(19) United States
(12) Patent Application Publication
(10) Pub. No.: US 2017/0270194 A1
(43) Pub. Date: Sep. 21, 2017

(54) SYSTEM AND METHOD OF IDENTIFYING ASSOCIATIONS AMONG ELECTRONIC TRADING DATA

(71) Applicant: Cortica, Ltd., TEL AVIV (IL)

(72) Inventors: Igal Raichelgauz, Tel Aviv (IL); Karina Odinaev, Tel Aviv (IL); Yehoshua Y Zeevi, Haifa (IL)

(73) Assignee: Cortica, Ltd., TEL AVIV (IL)

(21) Appl. No.: 15/612,643

(22) Filed: Jun. 2, 2017

Related U.S. Application Data
(63) Continuation-in-part of application No. 14/994,435, filed on Jan. 13, 2016.
Application No. 14/994,435 is a continuation of application No. 14/013,740, filed on Aug. 29, 2013, now Pat. No. 9,256,668.
Application No. 14/013,740 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 62/344,405, filed on Jun. 2, 2016.
(60) Provisional application No. 61/773,838, filed on Mar. 7, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30705; G06F 17/3002

(57) ABSTRACT

A method and system for identifying associations among electronic trading data. The method includes extracting a plurality of electronic trading data elements from input electronic trading data; generating at least one signature for each of the extracted electronic trading data elements; identifying a plurality of common patterns among the generated signatures; clustering the signatures having common patterns of the identified common patterns to create a plurality of signature clusters; and identifying, based on the plurality of signature clusters, at least one association between common patterns of the identified plurality of common patterns.

### CROSS-REFERENCE TO RELATED APPLICATIONS

This application claims the benefit of U.S. Provisional Application No. 62/344,405 filed on Jun. 2, 2016. This application is also a continuation-in-part (CIP) of U.S. patent application Ser. No. 14/994,435 filed on Jan. 13, 2016, now pending, which is a continuation of U.S. patent application Ser. No. 14/013,740 filed on Aug. 29, 2013, now U.S. Pat. No. 9,256,668, which claims the benefit of U.S. Provisional Application No. 61/773,838 filed on Mar. 7, 2013. The Ser. No. 14/013,740 Application is also a CIP of U.S. patent application Ser. No. 13/602,858 filed on Sep. 4, 2012, now U.S. Pat. No. 8,868,619, which is a continuation of U.S. patent application Ser. No. 12/603,123, filed on Oct. 21, 2009, now U.S. Pat. No. 8,266,185. The Ser. No. 12/603,123 Application is a CIP of:

(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a CIP of the above-referenced U.S. patent application Ser. No. 12/084,150;

(3) U.S. patent application Ser. No. 12/348,888 filed on Jan. 5, 2009, now pending, which is a CIP of the above-referenced U.S. patent application Ser. Nos. 12/084,150 and 12/195,863; and

(4) U.S. patent application Ser. No. 12/538,495 filed on Aug. 10, 2009, now U.S. Pat. No. 8,312,031, which is a CIP of the above-referenced U.S. patent applicationSer. Nos. 12/084,150; 12/195,863; and 12/348,888.

All of the applications referenced above are herein incorporated by reference for all that they contain.

### TECHNICAL FIELD

The present disclosure relates generally to the analysis of unstructured data, and more specifically to a system for identifying common patterns within electronic trading data.

### BACKGROUND

With the abundance of unstructured data made available through various means in general and the Internet in particular, there is also a need to provide effective ways of analyzing such data. Unstructured data analysis is a challenging task, as it requires processing of big-data. Big data typically refers to a collection of data sets that are large, complex, and cannot be analyzed using on-hand database management tools or traditional data processing applications.

Several existing solutions can be used to search through electronic trading data sources. As a result of the search, relevant data elements may be extracted from such electronic trading data sources. However, a problem may occur while trying to search for additional data that may be useful such as, for example, data containing characteristics that are similar to the characteristics of the extracted data. Typically, the complexity of big data leads to inefficient identification of common patterns within the data. In particular, existing solutions face challenges in effectively analyzing graphs, charts, and other visual elements that are commonly utilized for purposes such as electronic trading.

It would be therefore advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for identifying associations among electronic trading data. The method comprises: extracting a plurality of electronic trading data elements from input electronic trading data; generating at least one signature for each of the extracted electronic trading data elements; identifying a plurality of common patterns among the generated signatures; clustering the signatures having common patterns of the identified common patterns to create a plurality of signature clusters; and identifying, based on the plurality of signature clusters, at least one association between common patterns of the identified plurality of common patterns.

Certain embodiments disclosed herein also include a non-transitory computer readable medium having stored thereon causing a processing circuitry to execute a process, the process comprising: extracting a plurality of electronic trading data elements from input electronic trading data; generating at least one signature for each of the extracted electronic trading data elements; identifying a plurality of common patterns among the generated signatures; clustering the signatures having common patterns of the identified common patterns to create a plurality of signature clusters; and identifying, based on the plurality of signature clusters, at least one association between common patterns of the identified plurality of common patterns.

Certain embodiments disclosed herein also include a system for identifying associations among electronic trading data. The system comprises: a processing circuitry; and a memory, the memory containing instructions that, when executed by the processing circuitry, configure the system to: extract a plurality of electronic trading data elements from input electronic trading data; generate at least one signature for each of the extracted electronic trading data elements; identify a plurality of common patterns among the generated signatures; cluster the signatures having common patterns of the identified common patterns to create a plurality of signature clusters; and identify, based on the plurality of signature clusters, at least one association between common patterns of the identified plurality of common patterns.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for identifying associations among electronic trading data according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain example embodiments disclosed herein include a method and system for identifying associations among data elements extracted from electronic trading platforms. One or more common patterns are identified within the electronic trading data elements based on signatures generated for the electronic trading data elements. The generated signatures are clustered with respect to the identified common patterns. Associations among the common patterns are identified based on the clusters. In an embodiment, identifying the associations includes correlating among the generated clusters. The correlation refers to any of a broad class of statistical relationships involving at least two sets of data. The electronic trading data elements may include, but are not limited to, unstructured data elements that are not organized in a consistent or otherwise predictable manner.

In an example implementation, the electronic trading data elements may be, but are not limited to, graphs, formulas, prices, quantities, unstructured data sets multimedia content, a computer readable document, metadata, video, analog data, files, unstructured text, a web page, a combination thereof, a portion thereof, and the like. The correlations may be utilized to determine associations of the electronic trading data elements in space, in time, or both, with respect to the common patterns.

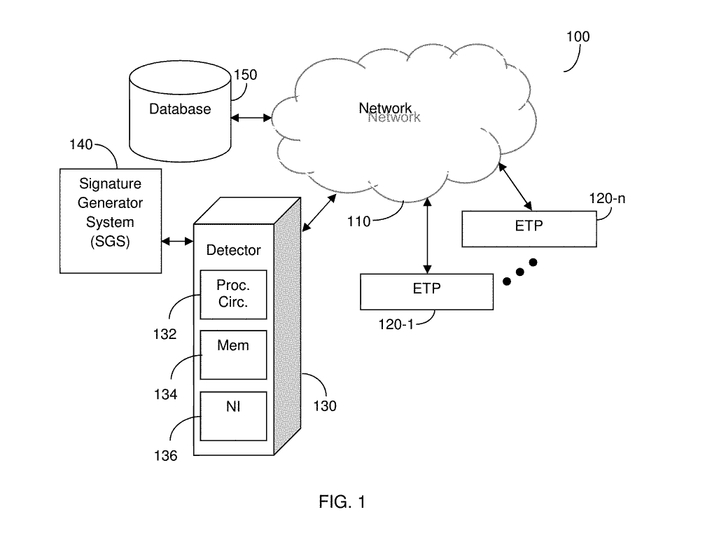

FIG. 1 shows an example network diagram 100 utilized to describe the various embodiments. A network 110 is used to communicate between different parts of the network diagram 100. The network 110 may be the Internet, the world-wide-web (WWW), a local area network (LAN), a wide area network (WAN), a metro area network (MAN), and other networks for enabling communication between the elements of the network diagram 100.

A pattern detector 130 is communicatively connected to the network 110. The pattern detector 130 is configured to correlate between unstructured data elements extracted from big data sources comprising unstructured data as described in detail below. The pattern detector 130 typically includes a processing circuitry 132 coupled to a memory 134. The memory contains instructions that, when executed by the processing circuitry, configure the pattern detector 130 to perform at least one of the methods described herein. The pattern detector 130 also includes a network interface 136. In some implementations, the processing circuitry 132 may be realized as a plurality of at least partially statistically independent computational cores configured to generate signatures as described further herein.

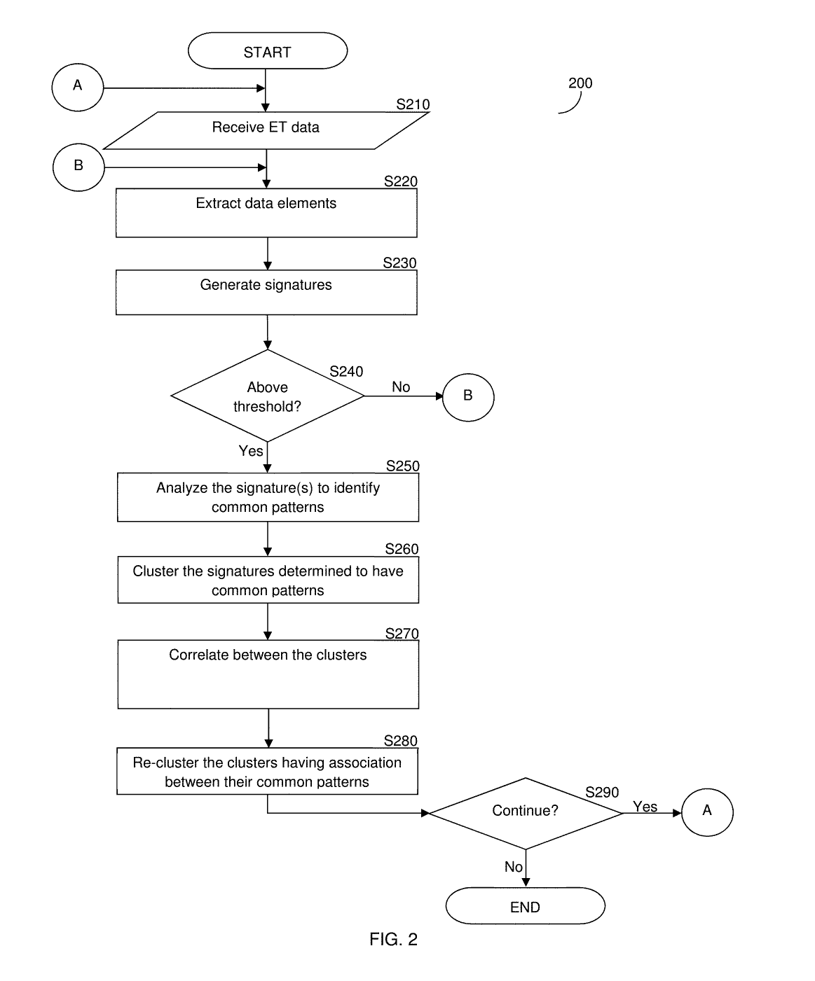

In an embodiment, a database 150 is communicatively connected to the pattern detector 130 (either directly or through the network 110). The pattern detector 130 is configured to store, in the database 150, results of analyzing electronic trading data elements for subsequent use. Such results may include, signatures generated for data elements, common patterns identified among data elements, common concepts identified among the common patterns, and so on, as described in greater detail herein below with respect of FIG. 2.

Further connected to the network 110 is a plurality of electronic trading platforms 120-1 through 120-n (hereinafter referred to individually as an electronic trading platform 120 and collectively as electronic trading platforms 120, merely for simplicity purposes), each of which may contain, store, or generate data associated with electronic trading. The electronic trading platforms 120 are accessible to the pattern detector 130, e.g., via the network 110.

The network diagram 100 also includes a signature generator system (SGS) 140. The SGS 140 is communicatively connected to the pattern detector 130. In an embodiment, the pattern detector 130 may be configured to receive or retrieve the electronic trading data elements from the electronic trading platforms 120, and to cause the SGS 140 to generate signatures to the electronic trading data elements.

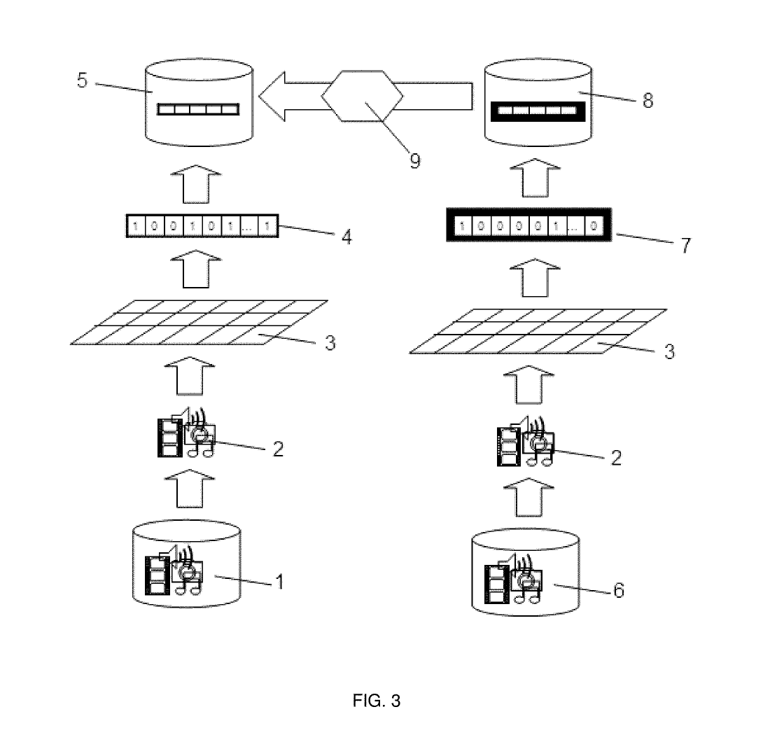

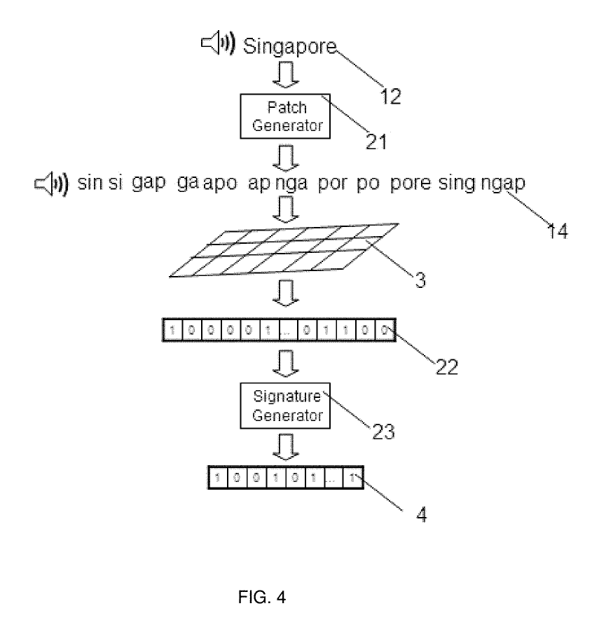

The SGS 140 is configured to at least generate signatures for multimedia content elements as described herein. To this end, the SGS 140 may include a plurality of at least partially statistically independent computational cores, where the properties of each core are independent of the properties of each other core. The process for generating the signatures for multimedia content elements is explained in more detail herein below with respect to FIGS. 3 and 4. Alternatively or collectively, the pattern detector 130 may include the SGS 140.

According to the various exemplary embodiments, the electronic trading data elements may include multimedia content elements. A multimedia content element may be, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof. In an example implementation, multimedia content elements of the electronic trading data elements include unstructured data, i.e., data lacking a known or otherwise expected structure. In a further example implementation, the electronic trading data elements may include visual multimedia content elements such as, but not limited to, graphs, charts, text, combinations thereof, and the like.

The pattern detector 130 is configured to receive or retrieve electronic trading data elements from at least one of the electronic trading platforms 120 and to provide such elements to the SGS 140. The SGS 140 is further configured to generate at least one signature for each electronic trading data element. The generated signature(s) may be robust to noise and distortion as discussed below with respect to FIGS. 3 and 4. Then, using the generated signature(s), the pattern detector 130 is configured to search for common patterns through the signatures. Upon identification of one or more common patterns through the signatures, the pattern detector 130 is configured to determine the correlation between the electronic trading data elements and the associations thereof.

In an embodiment, the signatures generated for more than one electronic trading data element are clustered. The clustered signatures are used to search for a common concept. A concept is a collection of signatures representing elements of the unstructured data and metadata describing the concept. As a non-limiting example, a ‘Superman concept’ is a signature reduced cluster of signatures describing elements (such as multimedia elements) related to, e.g., a Superman cartoon: a set of metadata representing proving textual representation of the Superman concept. Techniques for generating concepts are also described in the above-referenced U.S. Pat. No. 8,266,185 to Raichelgauz et al.

FIG. 2 is an example flowchart 200 illustrating a method for identifying associations among electronic trading data according to an embodiment. In an embodiment, the method may be performed by the pattern detector 130.

At S210, input electronic trading data is received or retrieved from at least one data source (e.g., at least one of the electronic trading platforms 120, FIG. 1). The at least one data source includes data sources storing data elements related to electronic trading.

As noted above, the input electronic trading data may include multimedia content elements. A multimedia content element may be, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof. In an example implementation, multimedia content elements of the electronic trading data include unstructured data, i.e., data lacking a known or otherwise expected structure. In a further example implementation, the electronic trading data may include visual multimedia content elements such as, but not limited to, graphs, charts, text, combinations thereof, and the like.

At S220, electronic trading data elements are extracted from the input electronic trading data received or retrieved at S210. In an embodiment, the extracted data elements are of specific interest, or are otherwise of higher interest than other elements of the input electronic trading data. As an example, a product's attributes and the sales volume of the product may be of interest. In addition, certain keywords may be of specific interest. As yet another example, portions of a multimedia element (e.g., a picture) having entropy level over a predefined threshold may be of more interest than other portions. In another embodiment, S220 includes searching patterns or patches in the electronic trading data, and extracting such identified patterns or patches. Typically, a patch of an image is defined by, for example, its size, scale, location and orientation. A video/audio patch may be, e.g., 1% of the total length of video/audio clip.

At S230, at least one signature is generated for each extracted electronic trading data element. In one embodiment, each of the at least one signature is robust to noise, distortion, or both, and is generated by a signature generator system as described further herein below.

At S240, it is checked if the number of extracted unstructured data elements are above a predetermined threshold, i.e., if there is sufficient information for the processing, and if so, execution continues with S250; otherwise, execution continues with S220.

At S250, the generated signatures are analyzed to identify common patterns among the generated signatures. In an embodiment, a process of inter-matching is performed on the generated signatures. In a further embodiment, the inter-matching process includes matching signatures of all the extracted elements to each other. Each match of two signatures is assigned a matching score which is compared to a preconfigured threshold. When the matching score exceeds the preconfigured threshold, the two signatures are determined to have a common pattern.

At S260, the signatures determined to have common patterns are clustered. In an embodiment, the clustering of the signatures is performed as discussed in detail in U.S. Pat. No. 8,386,400, entitled “Unsupervised Clustering of Multimedia Data Using a Large-Scale Matching System,” filed on Jul. 22, 2009, assigned to the common assignee, and which is hereby incorporated for all that it contains. It should be noted that S260 can result in a plurality of different clusters. As noted above, a cluster may include textual metadata.

At S270, the clusters are correlated to detect associations between common patterns indicated in the clusters. As a non-limiting example, if the common pattern of cluster A is ‘red roses’ and the common pattern of cluster B is ‘Valentine's Day’, then correlating among the clusters would result in detecting associations between ‘red roses’ and ‘Valentine's Day’. In an embodiment, a preconfigured threshold is used to determine if there is an association between at least two clusters of the created clusters. This preconfigured threshold defines at least a number of signatures to be found in two or more correlated-clusters in order to determine that there is an association between the clusters. The correlation can be performed between each set of two different clusters of the created clusters.

At S280, re-clustering clusters having associations between common patterns thereof to generate at least one concept representing the common pattern among two or more of the clusters. In an embodiment, S280 may include reducing the number of signatures in the re-clustered cluster and adding the respective metadata to the reduced cluster to form a concept. In another embodiment, S280 may include storing the generated signatures, the generated concept, the clusters, the common patterns, or a combination thereof, in a database for subsequent use.

At S290, it is checked whether additional electronic trading data has been received or retrieved, and if so, execution continues with S210; otherwise, execution terminates.

As a non-limiting example, several sales reports of worldwide retail chain stores are received by the pattern detector 130. The reports are analyzed and signatures are generated respective of each electronic trading data element within the reports. An electronic trading data element within the reports may be, for example, text indicating a certain product, or a certain product together with the quantity sold. Based on the generated signatures, common patterns are identified, and clusters of the generated signatures sharing a common pattern are generated. For example, a first common pattern of a first cluster of signatures indicates that, on every certain date (e.g., February 14^{th}), a significant amount of products which are packed in red packages are sold. A second common pattern of a second cluster of signatures indicates that an extensive amount of jewelry is sold in February. A third common pattern of a third cluster of signatures indicates an increase in sales of alcoholic beverages on the eve of February 14^{th}. Upon correlating between the plurality of clusters, consumption habits can be determined with respect to Valentine's Day. By analyzing the common patterns of the sales report, the pattern detector 130 enables determination of a common concept related to the plurality of common patterns. In this case, the common concept may be “during Valentine's Day people tend to spend more money.”

FIGS. 3 and 4 illustrate the generation of signatures for the multimedia content elements by the SGS 140 according to one embodiment. An example high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process will now be described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the pattern detector 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = θ ( Vi - Thx )$$

where, θ is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thx is a constant Threshold value, where x is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)^{l}<<1

i.e., given that /nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})≈l/L

i.e., approximately/out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. Detailed description of the Signature generation can be found in the above-noted U.S. Pat. Nos. 8,326,775 and 8,312,031.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications. Detailed description of the Computational Core generation, the computational architecture, and the process for configuring such cores is discussed in more detail in the above-referenced U.S. Pat. No. 8,655,801.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non- transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for identifying associations among electronic trading data, comprising:
extracting a plurality of electronic trading data elements from input electronic trading data;
generating at least one signature for each of the extracted electronic trading data elements;
identifying a plurality of common patterns among the generated signatures;
clustering the signatures having common patterns of the identified common patterns to create a plurality of signature clusters; and
identifying, based on the plurality of signature clusters, at least one association between common patterns of the identified plurality of common patterns.

2. The method of claim 1, wherein each signature is generated by a signature generator system, wherein the signature generator system includes a plurality of computational cores, each computational core of the plurality of computational cores having properties that are at least partly statistically independent of other cores of the plurality of computational cores, wherein the properties of each core are set independently of the properties of each other core.

3. The method of claim 1, wherein identifying the at least one association further comprises:
correlating among the plurality of signature clusters, wherein the at least one association indicates a relationship between at least a first common pattern of a first signature cluster and a second common pattern of a second signature cluster, wherein the first signature cluster and the second signature cluster are among the created plurality of signature clusters.

4. The method of claim 3, wherein identifying the at least one association further comprises:
re-clustering associated clusters of the plurality of clusters having an association between their respective common patterns to create at least one common concept, wherein each common concept represents the association between at least two associated clusters.

5. The method of claim 1, wherein the extracted electronic trading data elements are at least one of: of specific interest as compared to other electronic trading data elements of the electronic trading data, and of higher interest than other electronic trading data elements of the electronic trading data.

6. The method of claim 5, wherein each electronic trading data element of specific interest has an entropy level above a predetermined threshold.

7. The method of claim 1, wherein the input electronic trading data includes unstructured data from at least one electronic trading data source.

8. The method of claim 7, wherein each extracted electronic trading data element is a visual multimedia content element.

9. The method of claim 1, wherein identifying the common patterns further comprises:
matching the generated signatures to each other;
assigning a matching score to each pair of matched signatures;
comparing each matching score to a predetermined threshold; and
upon determining that one of the matching scores is above the predetermined threshold, determining the two signatures to have a common pattern.

10. A non-transitory computer readable medium having stored thereon instructions for causing a processing circuitry to execute a process, the process comprising:
extracting a plurality of electronic trading data elements from input electronic trading data;
generating at least one signature for each of the extracted electronic trading data elements;
identifying a plurality of common patterns among the generated signatures;
clustering the signatures having common patterns of the identified common patterns to create a plurality of signature clusters; and
identifying, based on the plurality of signature clusters, at least one association between common patterns of the identified plurality of common patterns.

11. A system for identifying associations among electronic trading data, comprising:
a network interface for allowing connectivity to a plurality of big data sources;
a processing unit; and
a memory connected to the processing unit, the memory containing instructions that, when executed by the processing unit, configure the system to:
extract a plurality of electronic trading data elements from input electronic trading data;
generate at least one signature for each of the extracted electronic trading data elements;
identify a plurality of common patterns among the generated signatures;
cluster the signatures having common patterns of the identified common patterns to create a plurality of signature clusters; and
identify, based on the plurality of signature clusters, at least one association between common patterns of the identified plurality of common patterns.

12. The system of claim 11, further comprising:
a signature generator system, wherein each signature is generated by the signature generator system, wherein the signature generator system includes a plurality of computational cores, each computational core of the plurality of computational cores having properties that are at least partly statistically independent of other cores of the plurality of computational cores, wherein the properties of each core are set independently of the properties of each other core.

13. The system of claim 11, wherein the system is further configured to:
correlate among the plurality of signature clusters, wherein the at least one association indicates a relationship between at least a first common pattern of a first signature cluster and a second common pattern of a second signature cluster, wherein the first signature cluster and the second signature cluster are among the created plurality of signature clusters.

14. The system of claim 13, wherein the system is further configured to:
re-cluster associated clusters of the plurality of clusters having an association between their respective common patterns to create at least one common concept, wherein each common concept represents the association between at least two associated clusters.

15. The system of claim 11, wherein the extracted electronic trading data elements are at least one of: of specific interest as compared to other electronic trading data elements of the electronic trading data, and of higher interest than other electronic trading data elements of the electronic trading data.

16. The system of claim 15, wherein each electronic trading data element of specific interest has an entropy level above a predetermined threshold.

17. The system of claim 11, wherein the input electronic trading data includes unstructured data from at least one electronic trading data source.

18. The system of claim 17, wherein each extracted electronic trading data element is a visual multimedia content element.

19. The system of claim 11, wherein the system is further configured to:
match the generated signatures to each other;
assign a matching score to each pair of matched signatures;
compare each matching score to a predetermined threshold; and
upon determining that one of the matching scores is above the predetermined threshold, determine the two signatures to have a common pattern.
